(19) United States
(12) Patent Application Publication
(10) Pub. No.: US 2016/0366932 A1
(43) Pub. Date: Dec. 22, 2016

(54) POCKET SMOKING PIPE

(71) Applicant: Georgiana Marie Weddington, New York, NY (US)

(72) Inventor: Georgiana Marie Weddington, New York, NY (US)

(21) Appl. No.: 15/185,859

(22) Filed: Jun. 17, 2016

Related U.S. Application Data
(60) Provisional application No. 62/181,265, filed on Jun. 18, 2015.

(51) Int. Cl. A24F 3/00; B25F 1/04; A24F 3/02; B26B 11/00; A24F 5/04; A24F 13/02

(52) U.S. Cl. CPC A24F 3/00; A24F 5/04; A24F 13/02; A24F 3/02; B26B 11/001; B25F 1/04

(57) ABSTRACT

A pocket pipe having a handle and a pipe is provided. The handle includes a first elongated side portion and a second elongated side portion disposed opposite of one another and defining a pipe cavity therebetween. The pipe includes a head portion and a pipe shaft extending from the head portion. A bowl is formed in the head portion. The head portion is pivotally secured to the handle in between the elongated side portions. The pipe includes a stowed position and an operative position. The stowed position includes the pipe substantially within the pipe cavity and the operative position includes the pipe shaft pivoted away from the pipe cavity as an extension of the handle.

### CROSS-REFERENCE TO RELATED APPLICATION

This application claims the benefit of priority of U.S. provisional application No. 62/181,265, filed Jun. 18, 2015, the contents of which are herein incorporated by reference.

### BACKGROUND OF THE INVENTION

The present invention relates to a smoking pipe and, more particularly, to a multi-function pocket pipe.

Marijuana is becoming increasingly legal in the United States. However, there are still stigmas attached to the use of the drug. Some medical marijuana smokers prefer to be discreet and use unobtrusive methods to medicate themselves. While pipes are singularly functional, they are obvious and indiscreet.

As can be seen, there is a need for a discreet smoking utensil.

### SUMMARY OF THE INVENTION

In one aspect of the present invention, a pocket pipe comprises: a handle comprising opposite, elongated side portions defining a pipe cavity therebetween, wherein a side of the handle comprises an opening leading into the pipe cavity; a pipe comprising a head portion comprising a bowl and a pipe shaft extending from the head portion, wherein the head portion is pivotally secured to the handle in between the elongated side portions, and the pipe comprises a stowed position and an operative position, wherein the stowed position comprises the pipe substantially within the pipe cavity and the operative position comprises the pipe shaft pivoted away from the pipe cavity as an extension of the handle.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a front view of an embodiment of the present invention;

FIG. 3 is a section view taken along 3-3 in FIG. 1;

FIG. 4 is a back view illustrating a carrying container of an embodiment of the present invention; and

FIG. 5 is a back perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a multi-function pocket pipe. The multi-function pocket pipe provides a discreet tool for quick dosage of medical marijuana and additional convenient implements for everyday uses. The pipe is discreet and doesn't reveal that the patient is a marijuana user to the public. The present invention gives medical marijuana smokers the best and most convenient implement to unobtrusively medicate themselves.

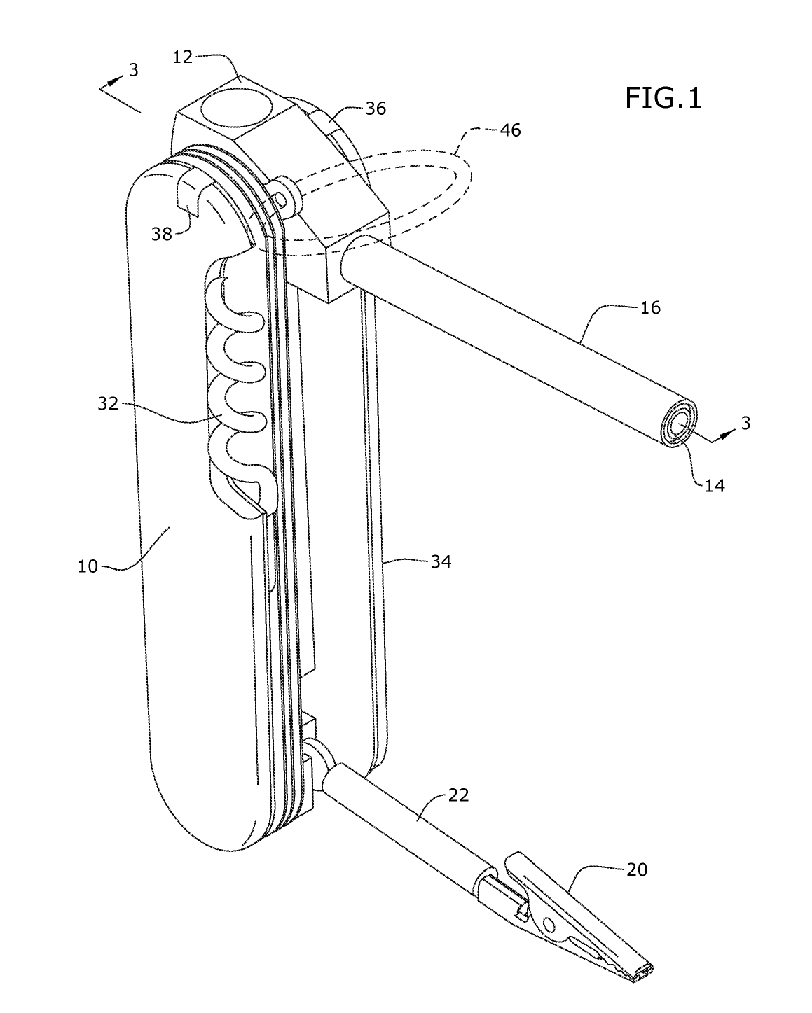

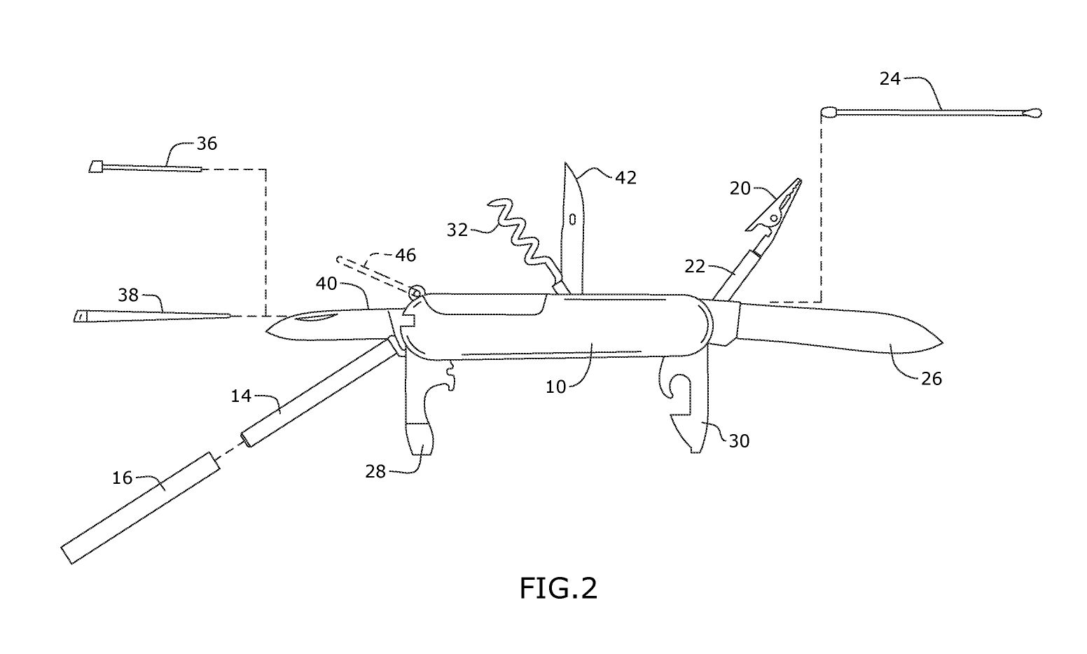

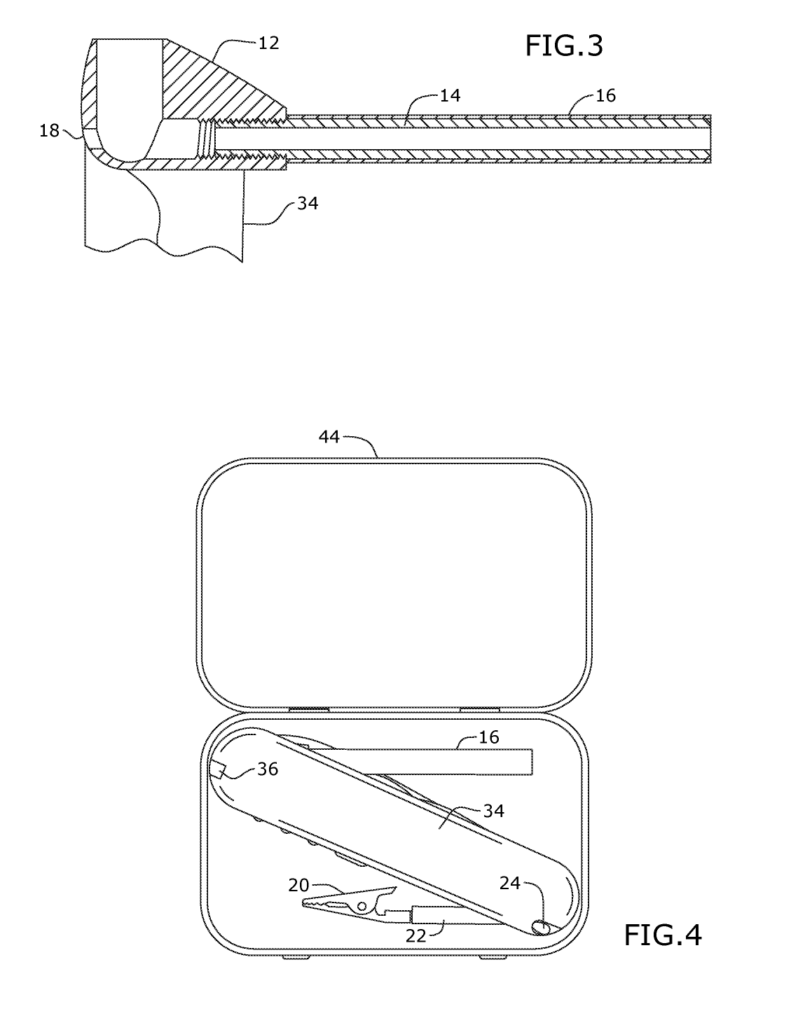

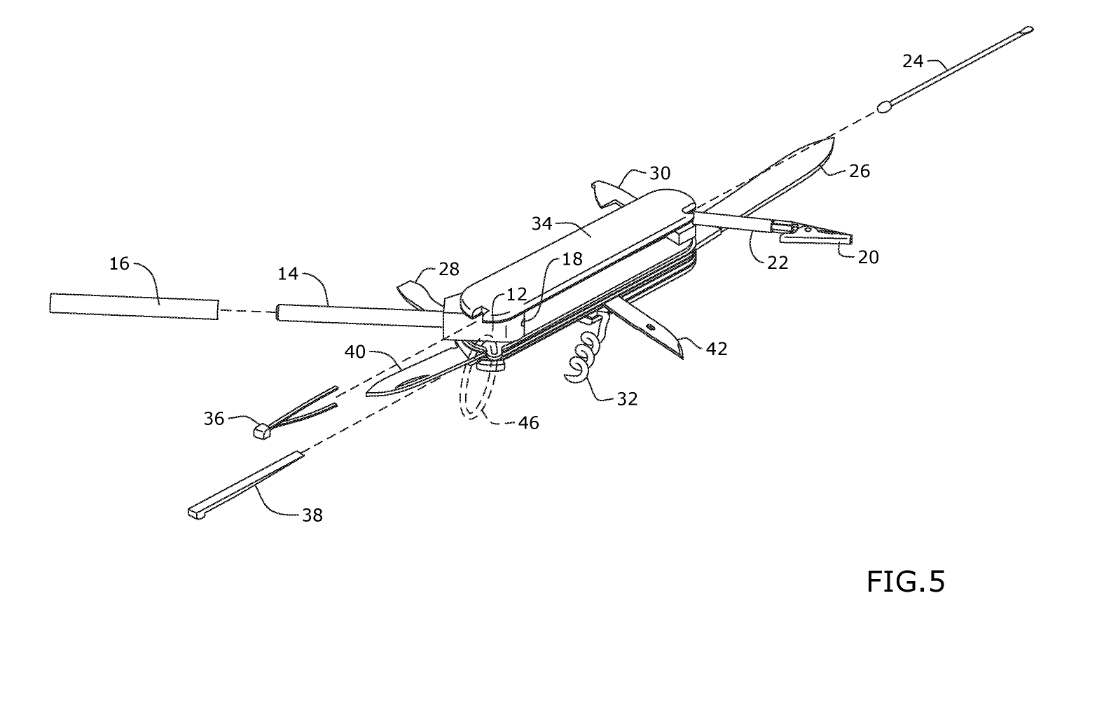

Referring to FIGS. 1 through 5, the present invention includes a pocket pipe having a handle and a pipe 12, 14. The handle includes a first elongated side portion 10 and a second elongated side portion 34 disposed opposite of one another and defining a pipe cavity therebetween. The pipe includes a head portion 12 and a pipe shaft 14 extending from the head portion 12. A bowl is formed in the head portion 12. The head portion 12 is pivotally secured to the handle in between the elongated side portions 10, 34. The pipe 12, 14 includes a stowed position and an operative position. The stowed position includes the pipe 12, 14 substantially within the pipe cavity and the operative position includes the pipe shaft 14 pivoted away from the pipe cavity as an extension of the handle.

In certain embodiments, the present invention may include a spring latch and a spacer. The spring latch and the spacer may be secured in between the elongated side portions 10, 34. The spring latch may bias the pipe 12, 14 in the stowed position and the operative position. Therefore, to use the pipe 12, 14, a user pivots the pipe 12, 14 out of the pipe cavity against the bias of the spring latch to the operative position. The spring latch biases the pipe in the operative position so that the pipe 12, 14 remains in the operative position until force is applied against the spring bias. Once the user has finished smoking, the user may pivot the pipe 12, 14 back into the pipe cavity. The spring latch biases the pipe 12, 14 in the stowed position so that the pipe 12, 14 remains in the stowed position until force is applied against the spring bias.

As mentioned above, the pipe 12, 14 is used for smoking. When in the operative position, a user may place a smokeable substance within the bowl of the head portion 12 and smoke the smokeable substance using the pipe shaft 14. Therefore, the pipe shaft 14 is fluidly connected with the bowl. A carburetor 18 may be formed at the head portion 12 through the bowl so that a user may clear the smoke from the pipe 12, 14. The pipe shaft 14 may be threadably attached to the head portion so that the pipe shaft 14 may be easily removed and the pipe 12, 14 may be cleaned. In certain embodiments, a sleeve 16 may fit around the stem 14.

Similar to a multi tool knife, the pocket pipe may include a plurality of tools. For example, the present invention may include a clip stem 22 having a spring clip 20 or a roach clip. The clip stem 22 is pivotally secured to the handle in between the elongated side portions 10, 34. The present invention may further include an awl 42, a small sized knife 40 and a large knife 26 pivotally secured to the handle in between the elongated side portions 10, 34. The present invention may further include a corkscrew 32, a bottle opener 28, and a can opener 30 pivotally secured to the handle in between the elongated side portions 10, 34. Each tool may be secured within a cavity formed in between the elongated side portions 10, 34 in a stowed position and pivoted away from the pipe cavity as an extension of the handle in an operative position. The spring latch may bias the tools in the stowed and operative position.

In certain embodiments, one or both of the elongated side portions 10, 34 may include slots. The slots may be sized to receive tweezers 36, a pipe cleaner 24 and a toothpick 38 within. A user may slide the tweezers 36, a pipe cleaner 24 and a toothpick 38 in and out of the slots to use them and to stow them.

The present invention is sized to fit within a user's pocket. The present invention may include a key ring 46 to attach to keys. In certain embodiments, the present invention may include a container 44. The container 44 may include a hinged front panel and rear panel. The pocket knife may be sized to fit in between the hinged panels when not in use.

The tools, pipe 12, 14 and elongated side portions 10, 34 may be attached with screws and pivot pins in a stacked formation allowing them to fold in and out of the handle. A medical marijuana user can simply insert a small amount of marijuana in the pipe 12, 14, discreetly smoke and fold it back quickly into the pocket knife. The roach clip can conveniently hold a hand rolled marijuana cigarette. The pipe cleaner 24 can remove the ashes from the pipe and insert marijuana into the pipe. The other tools disguise the overall use of the implement making it more discreet for the medical user.

It should be understood, of course, that the foregoing relates to exemplary embodiments of the invention and that modifications may be made without departing from the spirit and scope of the invention as set forth in the following claims.

What is claimed is:

1. A pocket pipe comprising:
a handle comprising opposite, elongated side portions defining a pipe cavity therebetween, wherein a side of the handle comprises an opening leading into the pipe cavity;
a pipe comprising a head portion comprising a bowl and a pipe shaft extending from the head portion, wherein
the head portion is pivotally secured to the handle in between the elongated side portions, and
the pipe comprises a stowed position and an operative position, wherein the stowed position comprises the pipe substantially within the pipe cavity and the operative position comprises the pipe shaft pivoted away from the pipe cavity as an extension of the handle.

2. The pocket pipe of claim 1, wherein the pipe shaft is threadably connected to the head portion.

3. The pocket pipe of claim 1, further comprising a sleeve disposed over the pipe shaft.

4. The pocket pipe of claim 1, wherein the head portion further comprises a carburetor.

5. The pocket pipe of claim 1, further comprising a clip stem comprising a spring clip, wherein the clip stem is pivotally secured to the handle in between the elongated side portions.

6. The pocket pipe of claim 1, further comprising at least one knife pivotally secured to the handle in between the elongated side portions.

7. The pocket pipe of claim 1, wherein the at least one knife comprises a plurality of knives pivotally secured to the handle in between the elongated side portions.

8. The pocket pipe of claim 1, further comprising a corkscrew pivotally secured to the handle in between the elongated side portions.

9. The pocket pipe of claim 1, further comprising a bottle opener pivotally secured to the handle in between the elongated side portions.

10. The pocket pipe of claim 1, wherein one of the elongated side portions comprises a slot sized to secured one of a tooth pick, a pipe cleaner, and tweezers within.
